(19) United States
(12) Patent Application Publication
(10) Pub. No.: US 2015/0107052 A1
(43) Pub. Date: Apr. 23, 2015

(54) HINGE ASSEMBLY

(71) Applicant: JOSEPH TALPE, HEESTERT-ZWEVEGEM (BE)

(72) Inventor: JOSEPH TALPE, HEESTERT-ZWEVEGEM (BE)

(21) Appl. No.: 14/517,371

(22) Filed: Oct. 17, 2014

(30) Foreign Application Priority Data
Oct. 18, 2013 (EP) 13189425.5

(51) Int. Cl. E05D 11/00; E05D 7/00; E05D 3/02

(52) U.S. Cl. CPC E05D 11/0018; E05D 3/02; E05D 7/0045; E05D 11/0054
USPC 16/251; 29/11; 29/402.03

(57) ABSTRACT

The hinge assembly for mounting on substantially parallel surfaces has an eye bolt including a threaded portion. A mounting member is positioned on the threaded portion of the eye bolt with two nut elements and connected to a gate by fixing means. The hinge assembly further has a mounting pin for connecting the eye bolt to the support. The hinge assembly has a securing cover mountable over the two nut elements and over at least a part of the fixing means of the mounting member connecting to the gate. The cover further has assembling means for assembling the cover to the eye bolt and the mounting pin still allowing displacement of the cover in the longitudinal direction of the eye bolt. The hinge assembly further has a cover support member for fixing the cover in the longitudinal direction preventing unauthorized dismounting of the gate.

### RELATED APPLICATIONS

The present application claims priority to European Patent App. No. 13189425.5, filed on 18 Oct. 2013. The application referred to in this paragraph is incorporated by reference as if set forth fully herein.

### TECHNICAL FIELD

The present invention relates to a hinge assembly for mounting on substantially parallel mounting surfaces and more specifically to a hinge assembly which secures against unauthorized dismounting.

The present invention further relates to a method for adjustment of a hinge assembly which secures against unauthorized dismounting.

### BACKGROUND ART

Hinge assemblies for mounting gates to a support are known. There is a large variety of hinge assemblies ranging from very simple assemblies where there is no adjustment and no prevention for dismounting to more complex assemblies that provide adjustment in three dimensions and prevent unauthorized dismounting.

One such more complex hinge assembly with adjustment in three directions is described in EP1528202. In EP1528202 a hinge mechanism for hanging a gate adjustable in three orthogonal directions on a support is disclosed. A problem with such a mechanism is that at least part of the mechanism is exposed and can be tampered with, and even removed, when the gate is in a closed and locked position to allow access through the gate. In this known hinge an eye bolt which is arranged between the first mounting member provided on the support and the second mounting member provided on the gate enables to adjust the distance between the support and the gate. A similar eye bolt hinge is disclosed in DE 10 2009 043 974. In these prior art hinge assemblies, the first mounting member has to be welded to the support whilst the second mounting member has to be welded onto the gate so that they cannot be dismounted from the support and the gate. The gate can however still be released easily by unscrewing the nut by means of which the second mounting member is fixed onto the eye bolt.

EP2317048 discloses a hinge assembly which prevents unauthorized dismounting. The hinge disclosed in EP231 7048 requires that the gate is mounted on the lateral side of the gate. Although this is useful for certain types of gates, this is not useful in case of very thin gates, in cases where the material of the gate has less strength on the side, or in cases where a small gap is desired between support and gate. In all these cases a hinge assembly which mounts to the gate on the front surface of the gate is required.

3-dimensional adjustable hinge assemblies for mounting on parallel mounting surfaces are known. An example is provided in FIG. 1A. The hinge assembly of FIG. 1A allows adjustment in the height direction and includes technology to prevent dismounting the hinge assembly from the support and to prevent dismounting the mounting pin. In the hinge assembly of FIG. 1A however someone could still access the screws connecting the hinge assembly to the gate such that unauthorized removal of the gate would still be possible.

EP 0 659 968 discloses a hinge assembly wherein the second mounting member is fixed by means of screws onto the front side of the opening member. To prevent access to these screws a cover is used, the distal extremity of which comprises a pin which is first hooked in a groove in the second mounting member whilst its proximal extremity is provided with two circular openings through which the hinge pin is inserted. A drawback of this known hinge assembly is that the distance between the support and the opening member cannot be adjusted without removing the cover from the hinge pin, i.e. without removing first the opening member from the support.

### DISCLOSURE OF THE INVENTION

It is an aim of the present invention to provide a hinge assembly for mounting to parallel mounting surfaces of a support and gate which is more secure than known mechanisms and which can be adjusted without having to remove the hinge pin, i.e. without having to release the opening member from the support. In other words, an aim of the present invention is to provide a hinge assembly which enables to adjust the distance between the support and the opening member by means of the eye bolt after having mounted the opening member to the support and after having assembled the cover onto the hinge pin.

This aim is achieved according to the invention with the hinge assembly showing the technical characteristics of the first independent claim.

In accordance with a first aspect of the invention, there is provided a hinge assembly for hingedly mounting an opening member to a support wherein a first and second mounting surface of respectively said support and said opening member are substantially parallel when said opening member is in a closed position. The hinge assembly comprises a first mounting member for connecting to said first mounting surface, an eye bolt mountable to said first mounting member and comprising an eye portion and a threaded portion, said threaded portion having a longitudinal direction perpendicular to an axis of rotation of the hinge assembly when assembled, a mounting pin for connecting said eye bolt to said first mounting member allowing rotational movement of said eye bolt relative to said first mounting member, a second mounting member for connecting to said second mounting surface and mountable to said eye bolt, said second mounting member comprising at least one fixing means for connecting said second mounting member to said second mounting surface, two nut elements for mounting said second mounting member to said threaded portion of said eye bolt, a securing cover mountable over said two nut elements and over at least a portion of said second mounting member, said portion including at least one of said at least one fixing means, assembling means for assembling said cover to said eye bolt and said mounting pin, which assembling means comprises at least one elongate slot in the cover for receiving said mounting pin, which elongate slot is elongated in said longitudinal direction of said eye bolt when assembled to allow displacement of said cover in said longitudinal direction of said eye bolt and a connection portion on the cover for moving over or hooking behind a free extremity of the threaded portion of said eye bolt restricting displacement of said cover to a displacement of the cover in said longitudinal direction of said eye bolt, and a cover support member arranged to be inserted between said cover and said eye bolt, in particular between said cover and the eye portion of the eye bolt, for fixing said cover in said longitudinal direction in a predetermined position.

The cover and the cover support member allow securing the hinge assembly in an easy way while it still allows adjusting the opening member with a minimum effort, in particular without having to remove the mounting pin. Using at least one elongate slot which receives the mounting pin has indeed the advantage that the mounting pin can move into this slot as well as rotate therein. The advantage of the connection portion which moves over or hooks behind a free extremity of the threaded portion of the eye bolt allowing still displacement in the length direction on the threaded portion is that this can be brought in a locked or unlocked position (locked or unlocked against rotation around the mounting pin) with a minimum on displacement. Because access to the essential fixing arrangements is prevented by the cover and the cover support member fixes the cover into his predetermined position, unauthorized dismounting of the opening member is prevented. Therefore, security is added. Furthermore, disassembling the cover support member allows adjusting the opening member without the need to fully dissembling the hinge assembly because the securing cover can at that moment be moved in the direction of the threaded portion to release it from the threaded portion such that the essential fixing arrangements can be accessed.

In one embodiment, the assembling means comprises two elongate slots for receiving said mounting pin, wherein said two elongate slots are elongated in said longitudinal direction of said eye bolt when assembled.

Using two elongate slots for receiving the mounting pin is beneficial to create axis of rotation.

In a further embodiment, said at least one fixing means is arranged for releasably connecting said second mounting member to said second mounting surface preferably by means of at least one screw. (The advantage of this embodiment is that the second mounting member does not need to be welded to the opening member, which is even not possible in case of for example a wooden opening member, but can simply be attached thereto, and also detached therefrom, by means of screws.

In still a further embodiment, the securing cover comprises a body portion and the connection portion is welded to the body portion.

Welding the connection portion to the body portion ensures a good fixation of the connection portion to the inside of the body portion without that this is visual on the outside of the cover.

In one embodiment, the connection portion comprises a portion substantially perpendicular to the longitudinal direction of said eye bolt.

The substantially perpendicular portion is advantageous during the process of positioning the securing cover in the hinge assembly.

In one embodiment, the connection portion moves over or hooks behind the free extremity of the threaded portion over a distance equal to or lower than a maximum displacement of said mounting pin in said at least one elongate slot of said cover.

Indeed, if the maximum displacement of the mounting pin in the elongate slot(s) is at least the same as the distance that the connection portion is moved over or hooked behind the threaded portion, the cover can be easily locked or released from the threaded portion without the need to disconnect the mounting pin from the elongate slots.

In a further embodiment, the connection portion is moved over or hooked behind said free extremity of said eye bolt in a first position of said at least one slots of said cover and is not moved over or hooked after said free extremity of said eye bolt in a second position of said at least one slots.

In still a further embodiment, the connection portion comprises a hole for moving over said free extremity of said threaded portion of said eye bolt.

Such a hole positions easily on a threaded portion of an eye bolt.

In one embodiment, the cover support member comprises fixing means for fixing said cover support member to a hole in said eye bolt, said hole being located at a side of the eye bolt directed towards the first mounting surface when said hinge assembly is in the closed position.

The positioning of the hole of the eye bolt at a side of the eye bolt directed towards the first mounting surface ensures that the cover support member cannot be disassembled when the opening member is closed.

In one embodiment, the fixing means for fixing the cover support member to a hole of the eye bolt retains also the mounting pin in the first mounting member.

By designing a concept wherein the fixing means provides two functionalities, the amount of components is reduced and thus the cost of the hinge assembly is reduced.

In one embodiment, the cover is made of metal such as stainless steel or by injection molding.

A cover made in metal such as stainless steel has the advantage that it will not be intentionally nor unintentionally destroyed or broken such that it would no longer be secured. Injection molding on the other hand is advantageous when large volumes have to be produced. In that case strong plastics can be used instead of metal.

In one embodiment, the cover has one side which is open, the open side facing in particular said first and second mounting surfaces when said opening member is in its closed position.

The shape of the cover allows to enclose the hinge assembly as much as possible.

It is another aim of the present invention to provide a method for assembling a securing cover in a hinge assembly for mounting on substantially parallel mounting surfaces.

This aim is achieved according to the invention with a method comprising the steps of assembling a securing cover with at least one elongate slot provided in said cover on said mounting pin still allowing displacement of said cover in said longitudinal direction of said eye bolt and with a connection portion for moving over or hooking behind a free extremity of the threaded portion of said eye bolt on said eye bolt in order to restrict displacement of said cover to a displacement of the cover in said longitudinal direction of said eye bolt and covering at least one of said at least one fixing means and said two nut elements with said cover, subsequently inserting a cover support member between said cover and said eye bolt for fixing said cover in the longitudinal direction in a predetermined position while the hinge assembly is in an open position, and fixing the cover support member to said eye bolt by means of fixing means which is not accessible when assembled and the hinge assembly is in a closed position.

It is still another aim of the present invention to provide a method for adjusting the positioning of an opening member whilst being securely and hingedly mounted to a support using a hinge assembly according to one of the embodiments of the present invention.

This aim is achieved according to the invention with a method comprising the steps of removing the cover support member from between the cover and the eye bolt when the opening member is in an open position, moving the securing cover in a translation movement relative to the eye bolt in the longitudinal direction of said threaded portion to release the cover from said eye bolt, moving the cover in a rotation movement relative to the eye bolt wherein the mounting pin provides an axis of rotation, adjusting said opening member by changing the position of said second mounting member with respect to said threaded portion of said eye bolt by moving said two nut elements on said threaded portion of said eye bolt.

### BRIEF DESCRIPTION OF THE DRAWINGS

For a better understanding of the present invention, reference will now be made, by way of example only, to the accompanying drawings.

FIG. 1A is a known example of a hinge assembly.

FIG. 1 illustrates an exploded view of a hinge assembly according to an embodiment of the present invention.

FIG. 2 is the hinge assembly of FIG. 1 now assembled and mounted on a support and a gate, the gate being in closed position.

FIG. 3 is a cross section of the hinge assembly mounted and positioned as in FIG. 2.

FIG. 4 shows an enlarged view of a portion of FIG. 3.

FIGS. 5 to 7 illustrate the steps for partial disassembly of the cover allowing adjustment of the gate. For clarity, gate and mounting member are omitted on FIGS. 5, 6 and 7.

FIG. 8 is a perspective view of the hinge assembly mounted on support and gate with the cover in an open, non-parallel position.

FIG. 9 shows different views of the body portion of the cover.

FIG. 10 shows different views of the connection portion of the cover.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

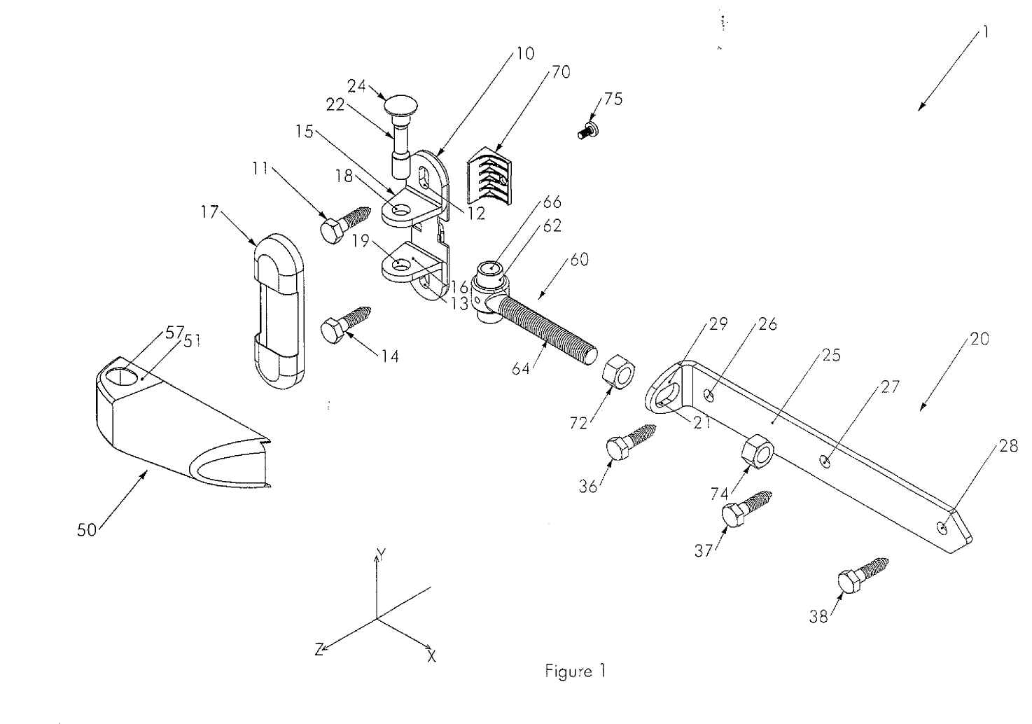

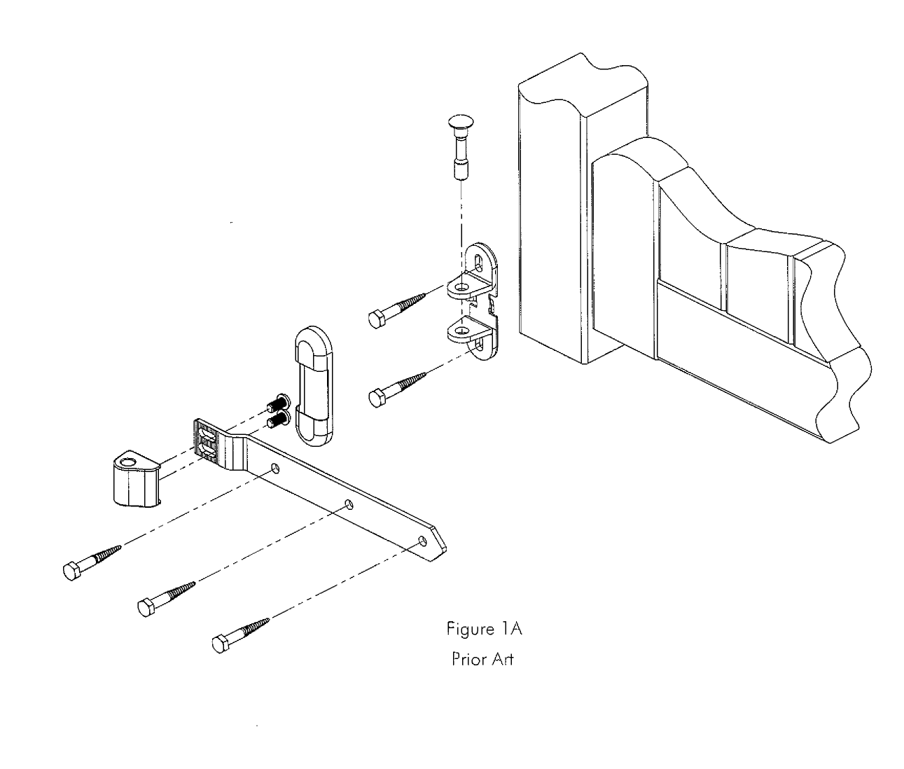

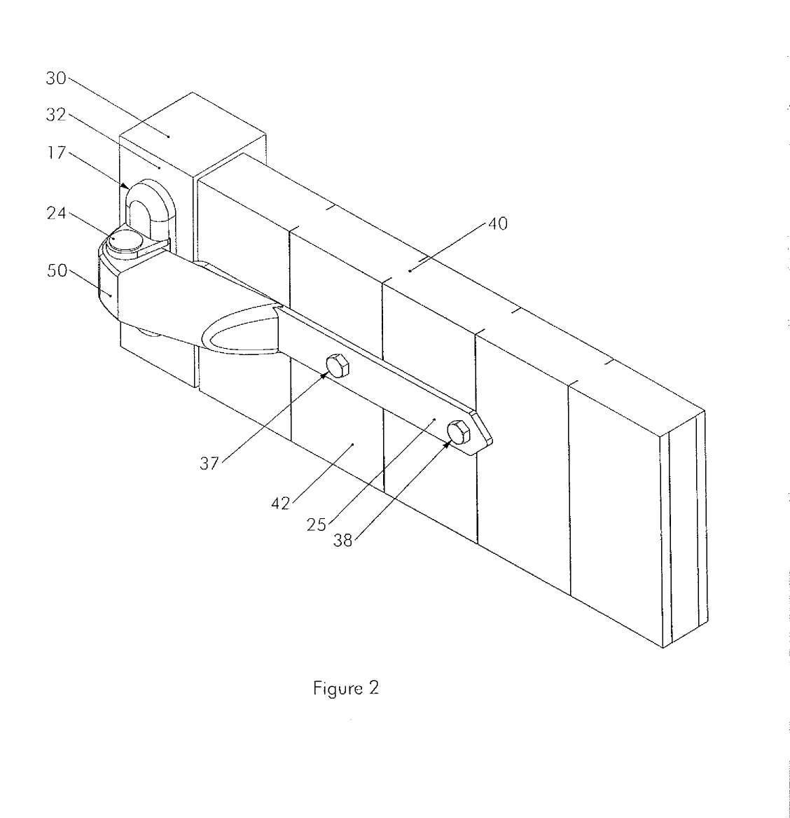

FIG. 1 shows an exploded view of a hinge assembly 1 in accordance with an embodiment of the present invention. The hinge assembly 1 has a first mounting member 10 for connecting the hinge assembly 1 to a support 30 (the support is not shown in FIG. 1 but is illustrated for example in FIG. 2). The first mounting member 10 comprises two elongate slots 12, 13. The elongate slots 12, 13 are elongated in the height direction allowing adjustment of the hinge assembly 1 in the height direction with respect to the fixed support 30 and at the same time, as a result of this, adjustment of a gate 40 in the height direction with respect to the fixed support 30 (gate 40 is shown for example in FIG. 2). The height direction is the Y-direction illustrated on FIG. 1. The first mounting member 10 further comprises two mounting plate portions 15, 16 having respective holes 18, 19. The first mounting member may be connected to support 30 by screws 11, 14. The type of screws 11, 14 are dependent on the type of material of support 30. In FIG. 1 wood screws are shown. Alternatively these screws are screws for concrete, metal, etc. or the screws may be replaced by any other type of connection such as for example welding. In the embodiment of FIG. 1, the hinge assembly 1 comprises a component 17 to cover the screws 11, 14. Component 17 prevents unauthorised dismounting of the first mounting member 10 from the support 30. Component 17 cannot be removed when hinge assembly 1 is assembled because mounting pin 24 prevents this.

The hinge assembly 1 further comprises a second mounting member 20 for connecting the hinge assembly 1 to a gate 40 or any other member who needs to be opened and closed by the hinge assembly 1, i.e. an opening member. The second mounting member 20 has a first portion 25 to be brought into contact with a mounting surface 42 of the gate 40. Portion 25 has three holes 26, 27, 28. Alternatively portion 25 may have more or less holes. Fixing screws 36, 37, 38 are provided for mounting the mounting member 20 on the gate 40. The type of the screws 36, 37, 38 is dependent on the material of the gate 40. In FIG. 1 wood screws are shown. Alternatively, screws for hollow or full aluminium profiles, screws for hollow iron or stainless steel profiles etc may be used. Also special connections may be used instead of screws such as for example Quick-Fix connections sold by Loxinox. The second mounting member 20 further comprises a second portion 29. Portion 29 has an elongate slot 21. Slot 21 is elongated in the direction substantially perpendicular to the mounting surface 42 of the gate 40. The elongate slot 21 allows adjustment of the gate 40 in the Z-direction illustrated on FIG. 1. Alternative, if no adjustment in the Z-direction is required, this slot can be circular.

The hinge assembly 1 further has an eye bolt 60. The eye bolt has an eye portion 62 and a threaded bolt portion 64 extending from the eye portion 62 as shown in FIG. 1. The eye portion 62 is used to mount the eye bolt 60 to the first mounting member 10 mounted on the support 30. A central aperture 66 is provided in the eye portion 62 through which a mounting pin 24 is inserted to retain the eye bolt 60 in position with respect to the first mounting member 10 as will be described in more detail below. The eye bolt 60 can rotate relative to the first mounting member 10 with the axis of the mounting pin 24 as the axis of rotation.

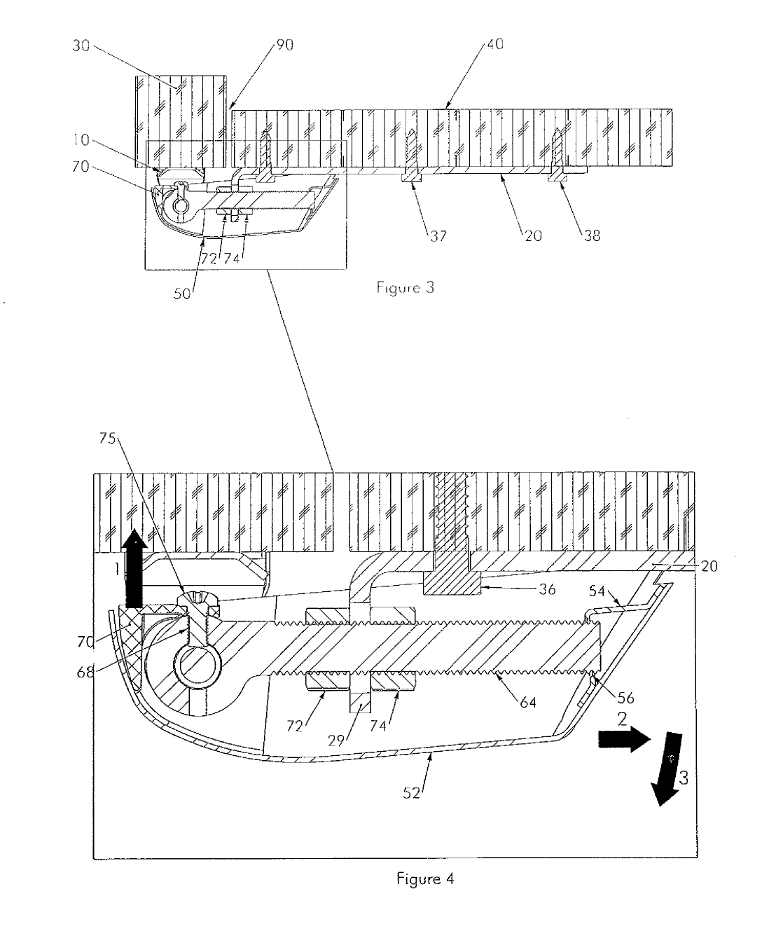

Mounting pin 24 has an annular recess or groove 22. The annular recess 22 receives a screw 75 when it is aligned with a hole 68 formed in the eye portion 62, the hole 68 extending into the central aperture 66 as illustrated on FIGS. 3 and 4. The engagement of the screw 75 with the annular recess 22 retains the mounting pin 24 within the first mounting member 10 but allows rotation movement of the eye bolt 60 about a longitudinal axis extending through the mounting pin 24. In the embodiment of FIG. 1 screw 75 has also another function as will be described in more detail below. In an alternative embodiment, screw 75 has no other function than retaining the mounting pin within the first mounting member. In still another alternative, the mounting pin is retained by a grub screw, a bolt or any other type of mounting pin known in the art may be used. Hole 68 formed in the eye portion is positioned such that the screw 75 can only be accessed (for mounting and more important for dismounting) when the longitudinal direction of the eye bolt 60 is sufficiently rotated from the closed position wherein the longitudinal direction of the eye bolt 60 is substantially parallel to the mounting surface 32 of the support 30, i.e in an open or non-parallel position of the gate 40. Moreover, screw 75 cannot be accessed (for mounting or dismounting) when the longitudinal direction of the eye bolt 60 is parallel to the mounting surface 32 of the support, i.e. in the closed or parallel position of the gate 40. This has the advantage that the mounting pin 24 cannot be removed when the gate 40 is in the closed position.

The threaded portion 64 of the eye bolt 60 is used to connect the eye bolt 60 with the second mounting member 20. Two nuts 72, 74 are provided. Nut 72 is mounted on the threaded portion 64 before the threaded portion 64 is inserted into elongate slot 21 of the second mounting member 20. This is shown more clearly in the cross section of FIG. 4. Nut 74 is subsequently mounted on the free end of threaded portion 64 such that second portion 29 of the second mounting member 20 is located between nuts 72, 74 on the threaded portion 64. The relative positioning of the threaded portion 64 of the eye bolt 64 with respect to the gate 40 provides adjustment in the X-direction illustrated on FIG. 1, i.e. the direction orthogonal to the elongate slot 21. Adjustment is the X-direction is in practice done by positioning the nuts 72, 74 on the threaded portion 64 of the eye bolt 60. Tightening the nuts 72, 74 on the threaded portion 64 of the eye bolt 60 so that the second portion 29 of the second mounting member 20 is clamped between two nuts 72, 74 fixes the eye bolt 60 to the second mounting member 20.

It should be noted that there are different sequences for mounting the gate 40 to the support 30. In one sequence the second mounting portion 53 have respective elongate slots 57, 59 for receiving mounting pin 24 when mounted. Side portion 55 forms the side wall between top portion 51 and bottom portion 53. Side portion 55 is curved to avoid that the cover would interact with component 17 which covers the first mounting member 10 or any of the other elements which are not rotating with the cover 50. On the side of the connection portion 54, the body portion 52 has a substantially flat side portion 69. The flat side portion 69 allows that the connection portion can be easily welded on the inside of the body portion. The cover has a cut-out 61 to receive the second mounting member 20 when assembled. This can be best seen in FIG. 2. By this cut-out 61 dimensioned to fit over the second assembly member 20, the structure ensures that the screw 36 cannot be reached because the sides of the cover 50 are mounted over the sides of the second mounting member 20 and the edge of the cover 50 at the cut-out 61 is mounted against or with a minimum gap to the second mounting member 20.

The method for assembling the cover 50 will now be described in more detail. Above there is indicated that the eye bolt 60 is connected to the first mounting member 10 by positioning the eye portion 62 with respect to the first mounting member 10 and to provide a mounting pin 24 through a central aperture 66 of the eye portion 62. The eye portion 62 is first positioned in cover 50 such that the central aperture 66 is aligned with the elongate slots 57, 59. Further, eye portion 62 and cover 50 are positioned in the first mounting member 10 such that central aperture 66, elongate slots 57, 59, and holes 18, 19 are aligned and can receive mounting pin 24. When the mounting pin 24 is brought into mounting position, cover 50 can still rotate with respect to the mounting pin 24 and cover 50 can still do a translation movement by relative movement of the mounting pin 24 in the elongate slots 57, 59. The slots 57, 59 have a width and a length. The width is determined by the diameter of the mounting pin 24. The length is determined by the distance over which the connection portion 54 of the cover 50 is applied over the free extremity of the eye bolt 60. Elongate slots 57, 59 have two extreme positions, one towards the outside and one towards the inside. When the mounting pin 24 is in the extreme outside position, the cover 50 can rotate with respect to the mounting pin 24 and with respect to the eye bolt 60, and portion 56 of connection portion 54 can be positioned substantially perpendicular to the longitudinal direction of the eye bolt 60. In that position, hole 58 of portion 56 is aligned with the threaded portion 64 of the eye bolt 50. The cover 50 can now be moved from the extreme outside position of the slots 57, 59 to the extreme inside position of the slots 57, 59, i.e. a translation movement. During that movement the threaded portion 64 is moving into the hole 58 of portion 56 of the connection portion 54. As soon as (and also as long as) the threaded portion 64 is received in the hole 58, the cover 50 is fixed except from movement in the X-direction.

To fix the cover 50 in the X-direction in a way that it prevents unauthorized dismounting, the hinge assembly further comprises a cover support member 70. When the cover 50 is positioned such that the mounting pin 24 is in the extreme inside position, the cover support member 70 can be brought in position between the cover body 52 and eye portion 62. The cover support member 70 is connected to the eye portion by screw 75. In the embodiment of FIG. 1, screw 75 is also used of mounting the mounting pin 24 as described above. In alternative embodiments, this can be two separate screws. In still other embodiments, the cover support member 70 can be assembled by another fixing means. Important for each of the fixing means is that disassembling of the cover support member is only possible in an open position of the gate and is not possible in the closed position of the gate. In the embodiment of FIG. 1, this is realized by positioning the screw such that the screw is not accessible in the closed or parallel position. As soon as the gate is sufficiently open, screw 75 can be reached and the cover support member 70 can be disassembled.

After assembly of cover 50, the hinge assembly 1 for substantially parallel mounting prevents unauthorized dismounting. Cover 50 prevents on the one hand access to nuts 72, 74 and on the other hand cover 50 prevents access to at least one of the screws 36 of the second mounting member 20. Therefore without disassembling cover 50, it's impossible to dismount the gate from the hinge assembly.

For adjustment of the gate 40, cover 50 can be partially disassembled. As described above, when the gate 40 is sufficiently open screw 75 can be accessed and dismounted. Cover support member 70 can now be disassembled. After removal of the cover support member 70, the cover 50 can be moved in a transitional movement relative to the eye bolt 60 until the threaded portion 64 of the eye bolt 60 is no longer inserted in hole 58 of portion 56 of the cover 50. In that position, cover 50 can be rotated relative to the eye bolt 60 providing access to nuts 72, 74 for adjustment of the gate 40. In this position, screw 36 is also accessible allowing dismounting of the gate 40.

FIG. 2 illustrates the hinge assembly 1 for substantially parallel mounting on a support 30 and a gate 40 in a perspective view. The combination of the technologies to prevent access to the first mounting member 10, to prevent dismounting of the mounting pin 24 and to prevent access to the second mounting member 20 provides a hinge assembly 1 which prevents unauthorized dismounting.

FIG. 3 is a cross section of FIG. 2 perpendicular to mounting surfaces 32, 42 and through the axis of the threaded portion 64 of the eye bolt 60. The gap 90 between the support 30 and the gate 40 is adjusted by the relative positioning of the second mounting member 20 on the eye bolt 60. Adjustment is executed by rotating the nuts 72, 74 in the one of the two directions.

FIG. 4 is an enlarged portion of a part of FIG. 3. FIG. 4 illustrates especially cover support member 70 assembled by screw 75. It's clear from FIG. 4 that in this closed, parallel position screw 75 is not accessible. It's also clear from FIG. 4 that, when the cover 50 is assembled, nuts 72, 74 nor screw 36 is accessible. FIG. 4 further includes arrows 1, 2 and 3 illustrating the steps for opening the cover 50 to allow access to nuts 72, 74 for adjustment or access to screw 36 for dismounting the gate 40 from the hinge assembly. As discussed above, first step is to remove the cover support member 70 illustrated by arrow 1. It's clear from FIG. 4 that this can only be done when the gate 40 is in a sufficiently open, non-parallel position. Arrow 2 illustrates the second step to do a relative translation movement between cover 50 and eye bolt 60. Arrow 3 illustrates the third step to do a relative rotation movement between the cover 50 and the eye bolt 60.

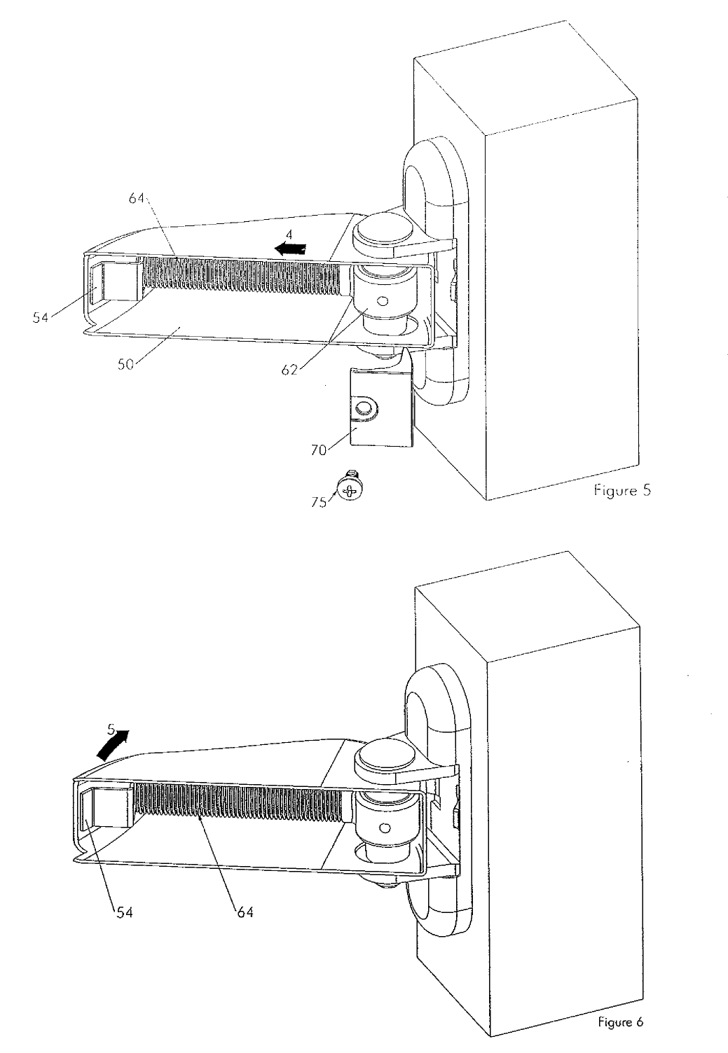

FIG. 5 illustrates the above described first step to remove the cover support member 70. The gate 40 and the second mounting member are omitted in this view for clarity. In FIG. 5 the eye bolt 60 (and thus in practice the gate 40) is sufficiently open to have access to the screw 75. In this position, screw 75 can be removed and subsequently the cover support member 70 can be removed between cover body 52 and eye portion 62. After removal, the threaded portion 64 of the eye bolt 60 is still inserted in the hole 58. The cover 50 is now ready to be moved in the direction of the arrow 4 on FIG. 5.

FIG. 6 illustrates the position of the cover 50 when it is moved according to the direction of the arrow 4 of FIG. 5. As discussed in detail above, the mounting pin 24 is now moved to the other side of the elongate slots 57, 59. In this position, the threaded portion 64 is no longer in the hole 58 of the position portion 54 of the cover 50. The cover 50 is now ready to be rotated in the direction of the arrow 5 on FIG. 6.

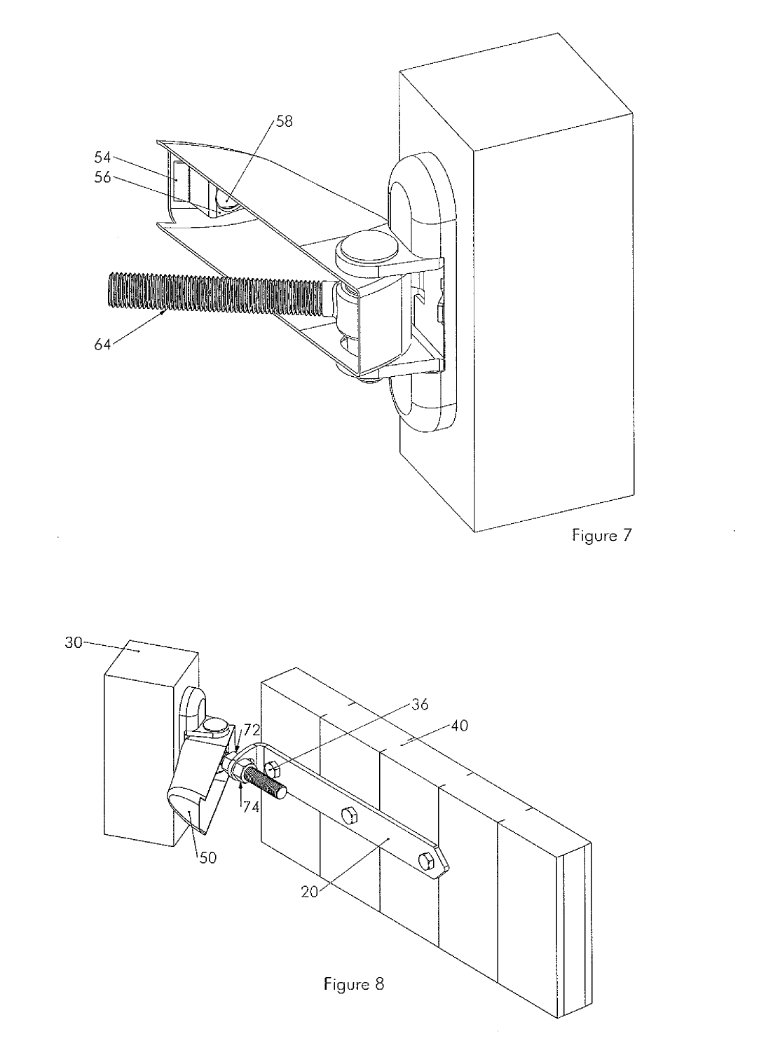

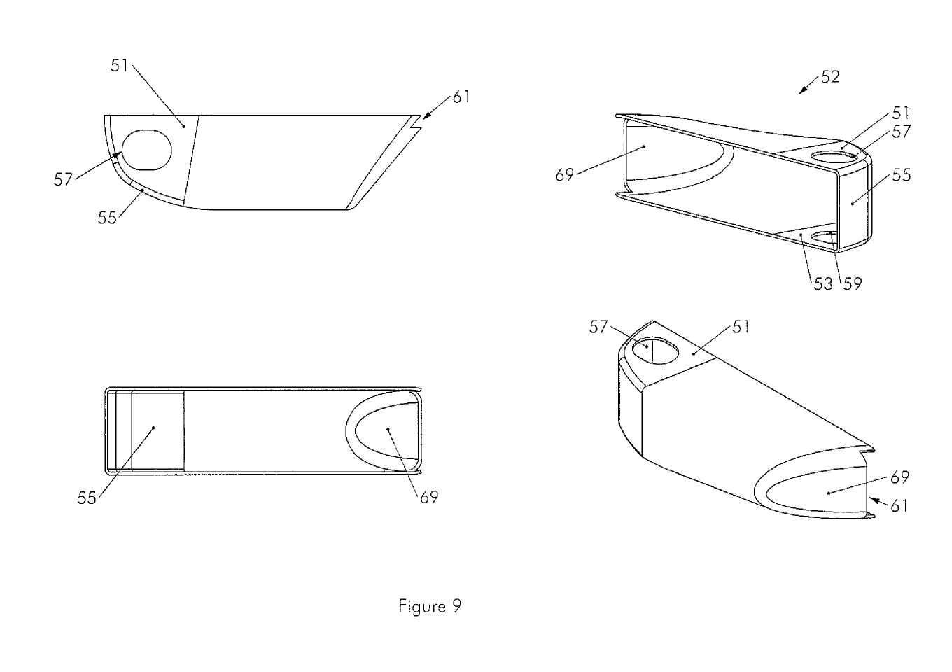

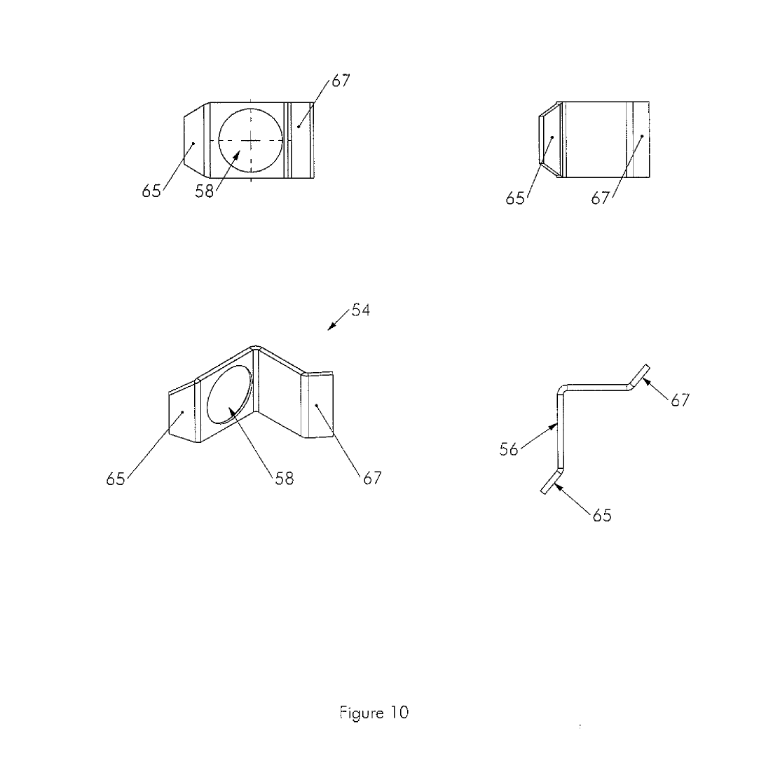

FIG. 7 illustrates the position of the cover 50 when it is rotated according to the direction of arrow 5 in FIG. 6. As discussed in detail below, in this position, adjustment and dismounting of the gate 40 is possible in this position.

FIG. 8 is a similar position as in FIG. 7 but now with the gate 40 and second mounting member 20 not omitted. FIG. 8 illustrates especially that in this position of cover 50 nuts 72, 74 are accessible to adjust the position of the gate 40 with respect to the support in the X-direction. This adjustment allows adjusting the gap 90 between support 30 and gate 40. This adjustment allows also positioning the gate 40 horizontal.

1. A hinge assembly for hingedly mounting an opening member to a support wherein a first and a second mounting surface of respectively said support and said opening member are substantially parallel when said opening member is in a closed position, comprising
a first mounting member for connecting to said first mounting surface;
an eye bolt mountable to said first mounting member and comprising an eye portion and a threaded portion, said threaded portion having a longitudinal direction perpendicular to an axis of rotation of the hinge assembly when assembled;
a mounting pin for connecting said eye bolt to said first mounting member allowing rotational movement of said eye bolt relative to said first mounting member;
a second mounting member for connecting to said second mounting surface and mountable to said eye bolt, said second mounting member comprising at least one fixing means for connecting said second mounting member to said second mounting surface;
two nut elements for mounting said second mounting member to said threaded portion of said eye bolt;
a securing cover mountable over said two nut elements and over at least a portion of said second mounting member, which portion includes at least one of said at least one fixing means;
assembling means for assembling said cover to said eye bolt and said mounting pin, which assembling means comprises at least one elongate slot in the cover for receiving said mounting pin, which elongate slot is elongated in said longitudinal direction of said eye bolt when assembled to allow displacement of said cover in said longitudinal direction of said eye bolt and a connection portion for moving over or hooking behind a free extremity of the threaded portion of said eye bolt restricting displacement of said cover to a displacement of the cover in said longitudinal direction of said eye bolt; and
a cover support member arranged to be inserted between said cover and said eye bolt for fixing said cover in said longitudinal direction in a predetermined position.

2. A hinge assembly as claimed in claim 1, wherein said cover support member is arranged to be inserted between said cover and the eye portion of said eye bolt.

3. A hinge assembly as claimed in claim 1, wherein said assembling means comprises two elongated slots for receiving said mounting pin, wherein said two elongate slots are elongated in said longitudinal direction of said eye bolt when assembled.

4. A hinge assembly as claimed in claim 1, wherein said at least one fixing means is arranged for releasably connecting said second mounting member to said second mounting surface preferably by means of at least one screw.

5. A hinge assembly as claimed claim 1, wherein said cover comprises a body portion and wherein said connection portion is welded to said body portion.

6. A hinge assembly as claimed in claim 1, wherein said connection portion comprises a portion which is at an angle, in particular substantially perpendicular, to the longitudinal direction of said eye bolt.

7. A hinge assembly as claimed in claim 1, wherein said connection portion moves over or hooks behind said free extremity of said threaded portion over a distance equal to or lower than a maximum displacement of said mounting pin in said at least one elongate slot of said cover.

8. A hinge assembly as claimed in claim 1, wherein said connection portion is moved over or hooked after said free extremity of said eye bolt in a first position of said at least one slots of said cover and is not moved over or hooked after said free extremity of said eye bolt in a second position of said at least one slots.

9. A hinge assembly as claimed in claim 1, wherein said connection portion comprises a hole for moving over said free extremity of said threaded portion of said eye bolt.

10. A hinge assembly as claimed in claim 1, wherein said cover support member further comprises fixing means for fixing said cover support member to a hole in said eye bolt, said hole being located at a side of the eye bolt directed towards the first mounting surface when said hinge assembly is in the closed position.

11. A hinge assembly as claimed in claim 10, wherein said fixing means retains said mounting pin in said first mounting member.

12. A hinge assembly as claimed in claim 1, wherein said cover is made of metal such as stainless steel or by injection molding.

13. A hinge assembly as claimed in claim 1, wherein said cover has one side which is open, the open side facing in particular said first and second mounting surfaces when said opening member is in its closed position.

14. A method for assembling a securing cover in a hinge assembly for mounting on substantially parallel mounting surfaces, said hinge assembly comprising a mounting member with at least one fixing means, an eye bolt comprising a threaded portion having a longitudinal direction perpendicular to the axis of rotation of the hinge assembly when assembled and connected to said mounting member with two nut elements, and a mounting pin through said eye bolt creating an axis of rotation of said hinge assembly, said method comprises the steps of:
assembling said cover with at least one elongate slot provided in said cover on said mounting pin still allowing displacement of said cover in said longitudinal direction of said eye bolt and with a connection portion for moving over or hooking behind a free extremity of the threaded portion of said eye bolt on said eye bolt in order to restrict displacement of said cover to a displacement of the cover in said longitudinal direction of said eye bolt, and covering at least one of said at least one fixing means and said two nut elements with said cover;
subsequently inserting a cover support member between said cover and said eye bolt for fixing said cover in said longitudinal direction in a predetermined position while said hinge assembly is in an open position;
and fixing the cover support member to said eye bolt by means of fixing means which is not accessible when assembled and said hinge assembly is in a closed position.

15. A method for adjusting the positioning of an opening member whilst being securely and hingedly mounted to a support using a hinge assembly as claimed in claim 1, said method comprising the steps of:
removing said cover support member from between said cover and said eye bolt when said opening member is in an open position;
moving said cover in a translation movement relative to said eye bolt in said longitudinal direction of said threaded portion to release said cover from said eye bolt;
moving said cover in a rotation movement relative to said eye bolt wherein the mounting pin provides an axis of rotation;
adjusting said opening member by changing the position of said second mounting member with respect to said threaded portion of said eye bolt by moving said two nut elements on said threaded portion of said eye bolt.
